(19) United States
(12) Patent Application Publication
(10) Pub. No.: US 2023/0082636 A1
(43) Pub. Date: Mar. 16, 2023

(54) PARITY DATA MODIFICATION FOR PARTIAL STRIPE DATA UPDATE

(71) Applicant: Micron Technology, Inc., Boise, ID (US)

(72) Inventors: Jiangli Zhu, San Jose, CA (US); Ying Tai, Mountain View, CA (US); Fangfang Zhu, San Jose, CA (US); Juane Li, Milpitas, CA (US)

(21) Appl. No.: 17/476,701

(22) Filed: Sep. 16, 2021

(51) Int. Cl. G06F 11/14

(52) U.S. Cl. CPC G06F 11/1415; G06F 11/1451; G06F 2201/82

(57) ABSTRACT

A system and method for recovery data generation for partial memory block modifications. An example system including a memory device and a processing device, operatively coupled with the memory device, to perform operations including: receiving a command to modify a portion of a memory block that is stored by the memory device, wherein the command comprises user data and a location in the memory block; reading user data at the location and existing recovery data for the memory block; generating recovery data for the memory block based on the existing recovery data, the user data at the location, and the user data of the command; and writing the user data of the command and the generated recovery data to the memory device, wherein the user data overwrites the portion of the memory block at the location.

### TECHNICAL FIELD

Embodiments of the disclosure relate generally to memory sub-systems, and more specifically, to modifying parity data when updating a portion of a memory block.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system and a host system, in accordance with some embodiments of the present disclosure.

FIG. 2 is a detailed block diagram of the memory sub-system in accordance with some embodiments of the present disclosure.

FIG. 3A is a diagram that illustrates an example of how the memory controller can process a command that modifies a smaller portion of a memory block, in accordance with some embodiments of the present disclosure.

FIG. 3B is a diagram that illustrates an example of how the memory controller can process a command that modifies a larger portion of a memory block, in accordance with some embodiments of the present disclosure.

FIG. 4 is a detailed block diagram of the memory controller of FIG. 2, in accordance with some embodiments of the present disclosure.

FIG. 5 is a flow chart of a method for processing a command that modifies a portion of a memory block that is associated with recovery data, in accordance with some embodiments of the present disclosure.

FIG. 6 is a block diagram of an example computer system in which embodiments of the present disclosure can operate.

### DETAILED DESCRIPTION

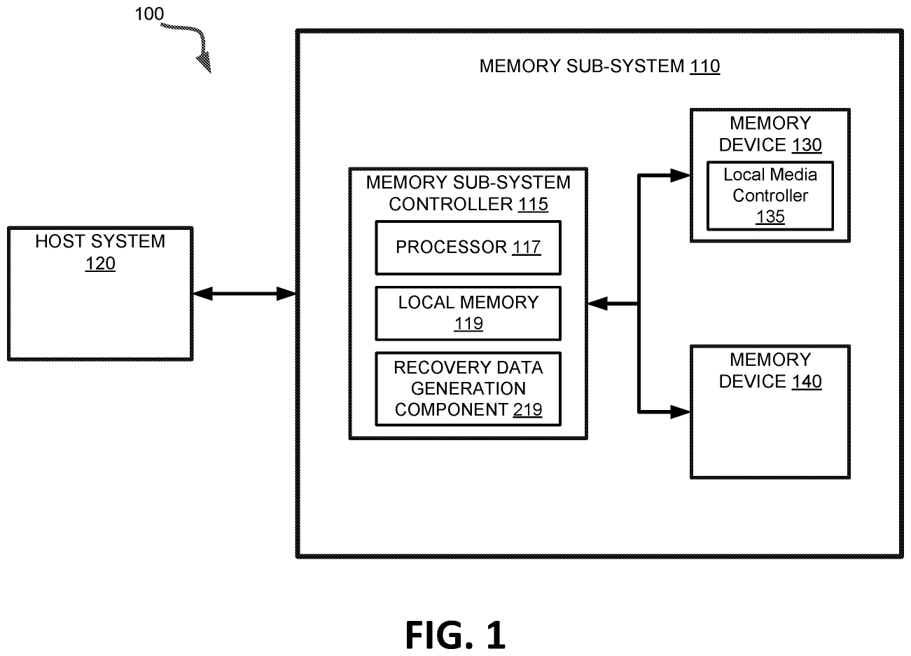

Aspects of the present disclosure are directed to the generation of recovery data (e.g., parity data) for commands that modify a portion of a memory block of a memory sub-system. The memory sub-system can be a storage device, a memory module, or a combination of a storage device and memory module. Examples of storage devices and memory modules are described below in conjunction with FIG. 1. In general, a host system can utilize a memory sub-system that includes one or more memory devices to store data. The host system can provide data to be stored by the memory devices of the memory sub-system and can request data to be retrieved from the memory devices of the memory sub-system.

The memory devices store the data as memory blocks and each memory block can correspond to recovery data. The memory sub-system can use the recovery data to recover the data if it becomes corrupt (e.g., cell failure), inaccessible (interconnect failure), or otherwise unavailable. When any portion of the data of a memory block is modified, the recovery data is regenerated to represent the modified memory block. There are many instances where a small portion of a memory block is modified and the remaining portion remains unmodified, which can be referred to as a partial memory block modification (i.e., partial modification). Processing the partial modification can involve buffering the modified portion and accessing the remaining portion of the memory block. The resulting data includes the data of the entire modified memory block and is used to regenerate the recovery data. The reads associated with accessing the remaining portions of the memory block can be costly and can reduce the performance of the memory sub-system.

Aspects of the present disclosure address the above and other deficiencies by providing technology that enables a memory sub-system to process partial memory block modification in a more computationally efficient manner. The memory sub-system can receive commands from a host system that modify a portion of a memory block (e.g., write, copy, or move command). The command can include a location within the block and may or may not include replacement data. The memory sub-system can use one or more memory controllers to process the command. Processing the command can involve reading the existing user data at the location and reading the existing recovery data associated with memory block. The memory controllers can then generate recovery data based on the existing recovery data, the existing user data, and the new user data. This enables the recovery data for the memory block to be replaced without reading the remaining portions of the memory block. In one example, generating the recovery data can involve read-modify-write operations and Exclusive OR (XOR) operations. The read-modify-write operations can access the existing data before it is overwritten and the XOR operations can use the existing data to generate the modified recovery data before the modified recovery data and the new user data are written to the memory block.

In one example, the memory controller can evaluate the size of the portion being modified and choose between different techniques to generate the recovery data. The portion being modified by a partial modification command can be any size that is less than the total size of a particular memory block. The smaller the size of the modified portion relative to the total size, the more beneficial it is to update the recovery data without reading the remaining portion of the memory block (e.g., partial block generation technique). When the modified portion is larger and closer to the total size it can be more beneficial to read the remaining portion of the memory block and generate the recovery data based on the entire memory block (e.g., entire block generation technique). The difference between the smaller and larger sizes can be based on a threshold size (e.g., half of total size or capacity). The memory controller can compare the size of the portion being modified to the threshold size. The memory controller can avoid reading the remaining portion of the memory block when the size is less than the threshold size and can read the remaining portion of the memory block when the size is greater than the threshold size.

Advantages of the technology disclosed herein include, but are not limited to, enhancing the speed, energy efficiency, lifetime, and failure avoidance of a memory sub-system. In one example, a memory block can have a total size (e.g., 1024 bytes+Recovery Data) that is broken into portions (e.g., 64 bytes each) that are striped across a set of memory devices. The memory controller can process the partial modification by performing a read-modify-write on the portion (e.g., 64 byte) and the recovery data without performing reads on the remaining portions (e.g., 15 other 64 byte portions). Reducing the number of reads and the quantity of data read can increase the speed and reduce energy consumption for processing a partial modification command. This can include other advantages, such as reducing the buffer space consumed by the memory controller, enhancing device wear, and other improvements.

FIG. 1 illustrates an example computing system 100 that includes a memory sub-system 110 and a host system 120 in accordance with some embodiments of the present disclosure. The memory sub-system 110 can include media, such as one or more non-volatile memory devices (e.g., memory device 130), one or more volatile memory devices (e.g., memory device 140), or a combination of such. Each memory device 130 or 140 can be one or more memory component(s).

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components or devices, which can be an indirect communicative connection or direct communicative connection (e.g., without intervening components or devices), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface, which can communicate over a system bus. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units (MUs).

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address (e.g., logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for memory management within the same memory device package. An example of a managed memory device is a managed NAND (MNAND) device.

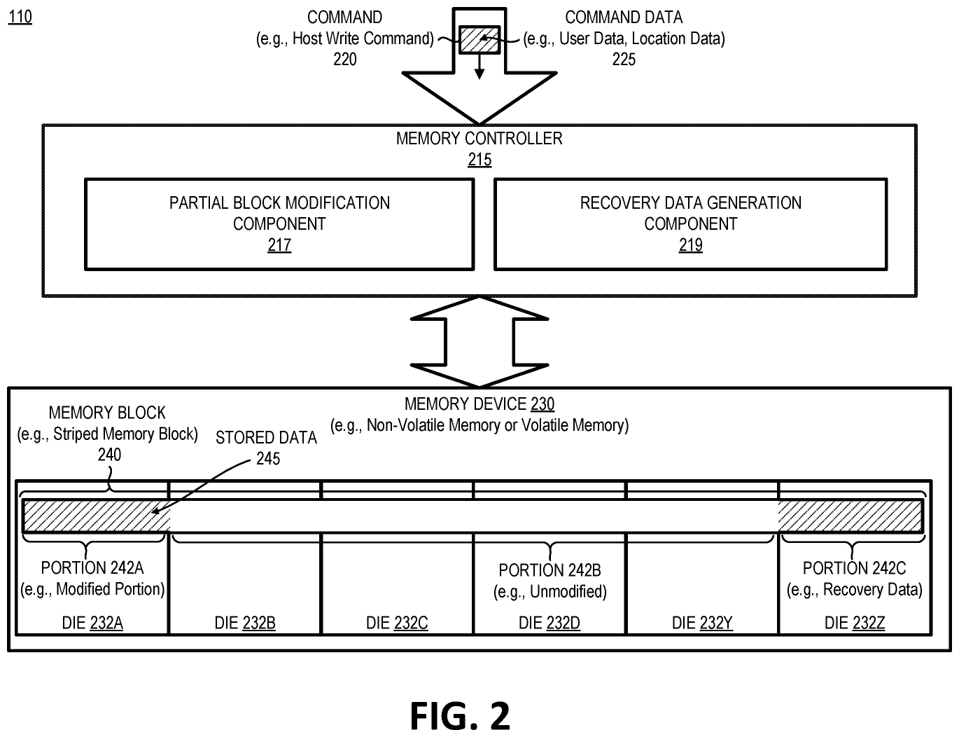

The memory sub-system 110 can include a recovery data generation component 219 that generates recovery data for commands that modify data stored on one or more memory devices 130, 140. Recovery data generation component 219 is discussed in more details below in regards to FIGS. 2-4.

FIG. 2 is a block diagram illustrating an exemplary memory sub-system 110 that includes a memory controller 215 with technology to generate recovery data for commands that partially modify a memory block, in accordance with some embodiments of the present disclosure. In the simplified example illustrated, memory sub-system 110 includes a memory controller 215, a command 220, a memory device 230, and a memory block 240 with portions 242A-C.

Memory controller 215 can be the same or similar to memory sub-system controller 115 and can include one or more media controllers (e.g., local media controller 135). Memory controller 215 can include one or more processing devices (e.g., core, processor, or other integrated circuit) that are electrically coupled or communicably coupled to memory device 230. In one example, memory controller 215 can be packaged with the memory device 230. In another example, memory controller 215 can be packaged separately from memory device 230 and be integrated with or a part of a central processing unit (host CPU), system on a chip (SOC), other processor, or a combination thereof. Memory controller 215 can be configured to generate, receive, or process command 220.

Command 220 can be any command that modifies data stored in memory device 230. Command 220 can be a write command, a move command, a copy command, a migrate command, a cryptographic command (e.g., encrypt or decrypt), an encoding command (e.g., encode or decode), other command, or a combination thereof. In the example shown, command 220 can be an external command that is generated by host system 120 and received by memory controller 215 over the physical host interface (e.g., Compute Express Link (CXL)). A command received from host system 120 and processed by memory controller 215 can be referred to as a host command, a front-end command, or other term. In another example (not shown), command 220 can be an internal command that is generated by memory controller 215 (e.g., by a central controller) and processed by memory controller 215 (e.g., by one or more local controllers) and can be referred to as a controller command, a media command, a memory sub-system command, or other term. In either example, command 220 can include command data 225.

Command data 225 can include location data, user data, operation data, other data, or a combination thereof. The location data that can be used by memory controller 215 to identify a particular location in memory. The location data can be or include an identifier that uniquely identifies memory block 240, portion 242A of memory block 240, memory device 230, memory sub-system 110, host system 120, or a combination thereof. The identifier can be in the form of one or more addresses, hashes, or offsets. The addresses can be physical addresses, logical addresses, virtual addresses, other addresses, or a combination thereof. The location data can indicate where to store the user data of command 220. The user data can be external data that is originally received from a source external to memory sub-system 110 and is different from internal data (e.g., recovery data, administrative data) discussed below. The operation data can include one or more instructions, opcodes, microcode, parameters, other data, or a combination thereof.

Memory controller 215 can process command 220 using partial block modification component 217 and recovery data generation component 219. Partial block modification component 217 can enable memory controller 215 to receive command 220 that modify a portion of memory block 240 without modifying the entire portion of memory block 240. Partial block modification component 217 can identify and evaluate the particular portion being modified. Recovery data generation component 219 can enable memory controller 215 to use different techniques to regenerate recovery data that represents the modified version of memory block 240.

Memory block 240 can be a unit of data storage that is stored by one or more memory devices (e.g., a memory storage unit). Each memory block can correspond to location data that can be used to uniquely identify the memory block and can be the same or similar to a memory block identifier (block ID), a block descriptor, a block label, or other term. A memory block can correspond to data on one or more memory devices and each memory device can store multiple memory blocks. The memory blocks can have a predefined size that can be based on (e.g., a multiple of) a size of another memory storage unit (e.g., cell, die, zone, device, or sub-system). The size of memory blocks can be a fixed size or a variable size. The fixed size (e.g., constant size or static size) means that the different memory blocks are the same size. The variable size (e.g., adjustable size, dynamic size) means that the different memory blocks can have different sizes. In one example, memory block 240 can be a striped memory block that is not contiguous and is striped across a set of portions (e.g., set of MUs). The set of portions can be all portions of the same memory device or each portion of the set can be on a different memory device. The one or more memory devices can be in a single DIMM package or different DIMM packages and can include non-volatile memory devices (e.g., NVRAM, PMEM), volatile memory devices (e.g., RAM), or a combination thereof.

Memory block 240 can be managed as a single storage unit and can be a contiguous or non-contiguous sequence of stored data 245. Stored data 245 of memory block 240 can include data that was provided to memory sub-system 110 and can include data generated by memory sub-system 110. The data provided to memory sub-system 110 can be referred to as user data or external data and can be externally accessible data that can be provided by host system 120 or another memory sub-system. The data generated by memory sub-system 110 can be referred to as internal data and can be data that is not externally accessible and is used for internal uses (e.g., recovery, management, mapping, maintenance, wear leveling, redundancy, etc.). In the example shown in FIG. 2, memory block 240 can include both user data and recovery data. In other examples, memory block 240 can include the user data without including recovery data. The recovery data can be associated (e.g., linked, mapped, affiliated) with the memory block but be stored separate from the memory block. In either example, memory block 240 can include one or more portions 242A-C.

Portions 242A-C are portions of memory block 240 that can be individually accessed and modified using command 220. A portion can be any portion of memory block 240 (e.g., a quarter, half, three quarters, whole memory block) and can be a portion (e.g., aggregate portion, composite portion, combined portion) that includes one or more other portions (e.g., constituent portions). Each of portions 242A-C can be stored on one or more dies 232A-Z.

In one example, each of dies 232A-Z can store its own portion of memory block 240. As shown in FIG. 2, portion 242A includes the user data being modified, portion 242B includes the user data that remains unmodified, and portion 242C includes the recovery data that is being modified. The recovery data can include redundancy data (e.g., duplicate data, parity data), error detection data (e.g., error detection codes, checksums, Cyclic Redundancy Check (CRC)), error correction data (e.g., error correcting code (ECC), forward error correction (FEC), erasure code), other data, or a combination thereof.

The recovery data can support or be based on any version of Redundant Array of Independent Disks (RAID), such as RAID 5. RAID 5 can involve block-level striping with distributed recovery data (e.g., distributed parity data). Unlike RAID 4, the recovery data can be distributed among the portions of memory. Upon failure of a single portion, subsequent reads can be calculated from the distributed recovery data such that no data is lost. RAID 5 can involve a minimum of three portions (e.g., dies, memory devices).

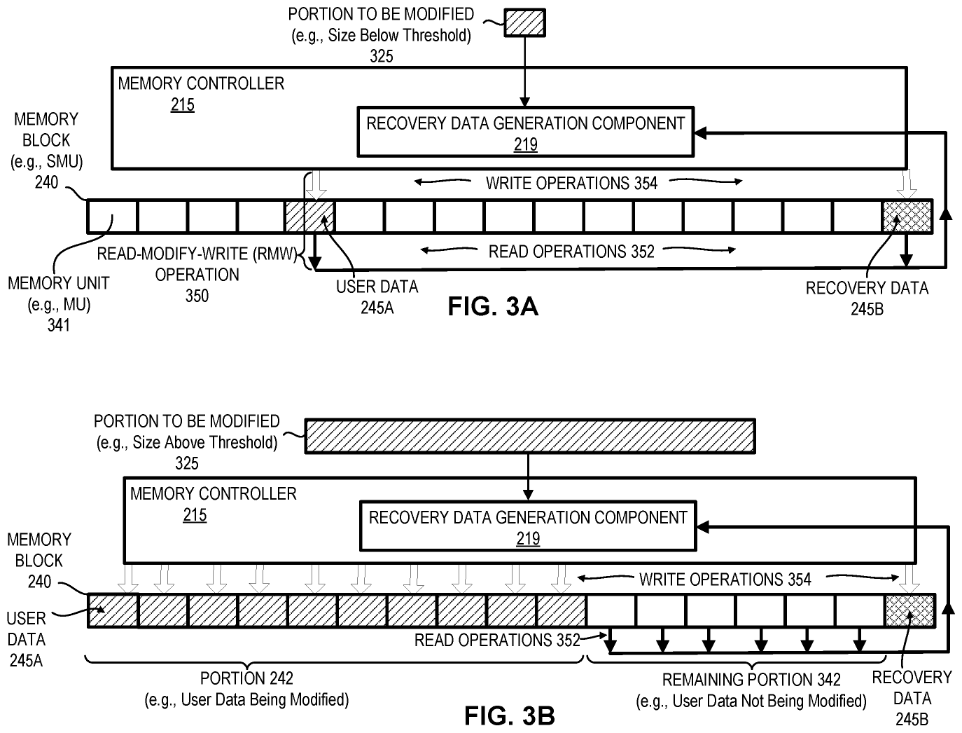

FIG. 3A and FIG. 3B illustrate how a memory controller 215 can process a command to modify a portion of a memory block without modifying the entire memory block, in accordance with some embodiments of the present disclosure. FIG. 3A and FIG. 3B each illustrate a different technique used by memory controller 215 to generate recovery data 245B that represents the modified version of memory block 240. FIG. 3A illustrates a technique that generates recovery data without reading the unmodified portion of memory block 240 and is useful when the portion being modified is smaller (e.g., less than half of memory block). FIG. 3B illustrates a technique to generate the recovery data by reading the remaining portion of the memory block and is useful when the portion being modified is larger (e.g., most but not all of memory block 240).

As shown in FIGS. 3A-3B, memory block 240 can include a set of memory units 341 (e.g., 16+1 units). A memory unit can be the smallest accessible unit of data from a memory device. In one example, memory block 240 can be a Super Management Unit (SMU) with a fixed block size (e.g., 1024B+recovery data 245B) and each memory unit 341 can be a Management Unit (MU) with a fixed unit size (e.g., 64 byte). The portion being modified can include a subset of the memory units in the set and the memory units in the subset can be adjacent (e.g., a contiguous portion), non-adjacent (e.g., non-contiguous), or a combination thereof. The size of memory block 240 and memory unit 341 can be determined (e.g., detected, identified, or selected) by memory sub-system 110, memory controller 215, memory devices 230, host system 120, other entity, or a combination thereof.

Referring to FIG. 3A, memory controller 215 can use a first technique that generates recovery data 245B without reading the portions of memory block that are not being modified (e.g., partial block generation technique). Memory controller 215 can perform the first technique by reading the existing data (e.g., original data) before replacing the existing data with the modified data. The existing data can include an existing version of user data 245A (e.g., existing user data) and an existing version of recovery data 245B (e.g., existing recovery data). The existing data can be read into a first buffer (e.g., read buffer) without reading the remaining portions of the memory block. Memory controller 215 can then use recovery data generation component 219 to generate recovery data that represents the modified version of the memory page. The replacement recovery data and the replacement user data (e.g., portion to be modified 325) can be stored in a second buffer (e.g., write buffer). Memory controller 215 can then write the data from the second buffer to memory block 240. The replacement user data can be stored at the portion with user data 245A and replacement recovery data can be stored at the portion with recovery data 245B. In one example, the first technique can use one or more read-modify-write (RMW) operations 350 to perform read operations 352 and write operations 354. A read-modify-write operation can be a single atomic operation (e.g., transaction) that sequentially reads existing data (e.g., original data) from a memory location and writes replacement data to the memory location.

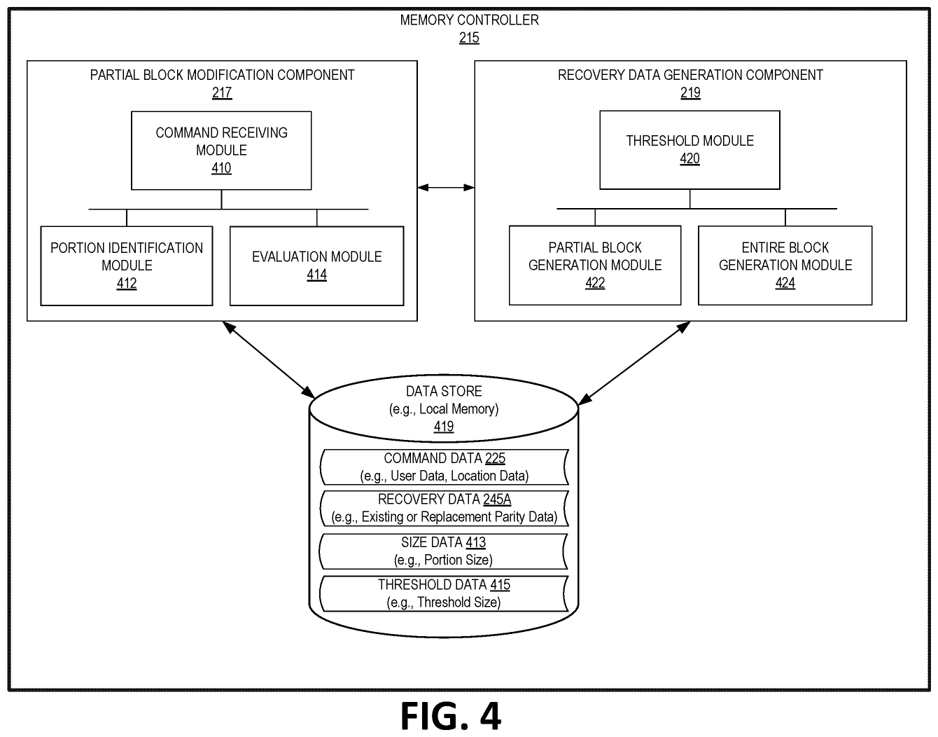

Referring to FIG. 3B, memory controller 215 can use a second technique that generates recovery data 245B by reading the remaining portion 342 of memory block 240 (e.g., entire block generation technique). Memory controller 215 can perform the second technique without reading the existing data at portion 242 since it is going to be modified but reads all of the remaining portion 342 of memory block 240. The existing user data 245A can be read into a first buffer (e.g., read buffer) without reading the existing recovery data 245B. Memory controller 215 can then use recovery data generation component 219 to generate recovery data that represents the modified version of the memory page. The replacement recovery data and the replacement user data (e.g., portion to be modified 325) can be stored in a second buffer (e.g., write buffer). Memory controller 215 can then write the data from the second buffer to memory block 240. The replacement user data can be used to overwrite user data at portion 242 of memory block 240 and replacement recovery data can be used to overwrite recovery data 245B of memory block 240. The recovery data generation component 219 and how to select between the two techniques are discussed in more detail in regards to FIG. 4.

FIG. 4 is a block diagram illustrating an exemplary memory controller 215 that includes technology for generating recovery data for a partially modified memory block, in accordance with some embodiments of the present disclosure. The features discussed in regards to the components and modules of FIG. 4 can be implemented in software logic (e.g., firmware, software, or other program code) or hardware logic (e.g., integrated circuits or other circuitry) of memory controller 215. More or less components or modules can be included without loss of generality. For example, two or more of the components can be combined into a single component, or features of a component can be divided into two or more components. In the example illustrated, memory controller 215 can include a partial block modification component 217 and a recovery data generation component 219.

Partial block modification component 217 can enable memory controller 215 to receive and process commands that modify a portion of a memory block without modifying the entire memory block. In the example illustrated, partial block modification component 217 can include a command receiving module 410, a portion identification module 412, and an evaluation module 414.

Command receiving module 410 can enable memory controller 215 to receive a command that modifies a portion of a memory block (e.g., partial block modification command). The command can be received from a host-system over a physical host interface or can be received from another part of memory controller 215. The other part can handle internal administrative functions (e.g., recovery, encryption, encoding, wear leveling, deduplication, migration). The command can be stored in a processing queue with one or more other commands. The command can be separated into different commands, aggregated with the other commands, or otherwise transformed before, during, or after the command is stored in the processing queue (e.g., command receipt queue). The one or more commands can include command data 225 and be stored as command data 225 in data store 419.

Command data 225 can include location data identifying one or more locations of a memory block (e.g., address of portion), user data to store at the one or more locations (e.g., replacement data), other data, or a combination thereof. In one example, a command can include location data that identifies an address within the memory block and can include user data that will be written to the location (e.g., 64 byte chunk of user data). In another example, the command can include location data without including any user data (e.g., absent or free of user data). This can occur when the command involves moving, removing, copying, or writing user data that already exists on one or more of the memory devices (e.g., for memory defragmentation, memory migration, memory wiping, memory deduplication, memory in-place encryption). In another example, the command can include user data without any location data (e.g., absent or free of location data). This can occur when the memory controller can determine (e.g., select, calculate) the location in a memory block to store the user data.

Portion identification module 412 can enable memory controller 215 to identify the portion being modified. The portion can be a portion of one or more memory blocks and can include one or more partial portions of a memory block (e.g., less than an entire portion), whole portions of a memory block (e.g., an entire portion), or a combination thereof. Portion identification module 412 can identify the location of the portion based on the location data. When the portion is a partial portion it can be located anywhere from the start of a memory block to the end of the memory block. In one example, the location data can include a pointer to the beginning, end, or intermediate location of the portion. The pointer can be an address of the portion or an address of the memory block with an offset to the portion. In one example, the memory controller can manage a set of memory devices and each memory block can be a striped memory block that is striped across the set of memory devices. Portion identification module 412 can determine a portion includes a set of sub-portions to be modified (e.g., memory units to be modified) and that each sub-portion of the set is stored on one of the memory devices in the set.

Evaluation module 414 can enable memory controller 215 to evaluate the portion being modified and determine its size. The size of the portion can be stored as size data 413 in data store 419. Size data 413 can include one or more decimals, integers, other values, or a combination thereof. Size data 413 can represent a portion's absolute size, relative size, or a combination thereof. The absolute size can be a value that represents a quantity of bits, bytes, units, or blocks being modified (e.g., 128 bytes) and can be independent of the size of the memory block being modified. The relative size can be a value that is relative to a base size, such as the base size of the memory block (e.g., SMU), memory unit (e.g., MU), memory device (e.g., Die or DIMM), interconnect width (e.g., bus width), or other portion of memory sub-system. The value of the relative size can represent one or more ratios, proportions, percentages, or fractions (e.g., ½, 1:2, or 50% of the memory block).

Recovery data generation component 219 can enable memory controller 215 to choose between different techniques for generating and updating the recovery data for a memory block. Memory device 230 can processes commands (e.g., partial write commands) that modify different size portions of the memory block. The commands that modify a smaller portion of a memory block can use a technique that generates recovery data using a partial memory block (e.g., not all of the user data of the memory block). The commands that modify a larger portion of the memory block can use a technique that generates recovery data using an entire memory block (e.g., all the user data of the memory block). In the example illustrated in FIG. 4, recovery data generation component 219 can include a threshold module 420, a partial block generation module 422, and an entire block generation module 424.

Threshold module 420 can enable memory controller 215 to choose between the different techniques based on threshold data 415. Threshold data 415 can include one or more thresholds and each threshold can correspond to one or more values. The threshold can be a threshold size that is the same or similar to the size discussed above (e.g., absolute size, relative size, quantity, percentage, ratio, etc). Threshold module 420 can analyze size data 413 and threshold data 415. The analysis can involve one or more comparisons between the portion size and threshold size to determine whether the portion being modified is a less than the threshold size (e.g., smaller portion) or is greater than or equal to the threshold size (e.g., larger portion). Responsive to the modified portion being less than the threshold size, the partial block generation module 422 can be used. Responsive to the modified portion being greater than the threshold size, the entire block generation module 424 can be used.

Partial block generation module 422 can enable memory controller 215 to generate recovery data based on a partial portion of memory block 240. The generated recovery data corresponds to an entire portion of the memory block even though it is generated using the partial portion and without using the entire portion of the memory block. The partial portion can include the existing user data at the portion that is being modified and the existing recovery data. Accessing the partial portion of data used to generate the recovery data can involve executing one or more read operations that include a read operation targeting the portion of the memory block and a read operation targeting the recovery data for the memory block. The existing recovery data can be read from locations internal to the memory block or from locations external to the memory block. The internal locations can be at the beginning of the memory block, at the end of the memory block, or any location there between. The external locations can be associated with (e.g., linked to or linked from) the memory block and may or may not be adjacent to the memory block (e.g., before, after, above, or below).

Partial block generation module 422 can then generate replacement recovery data based on the existing recovery data, the existing user data, the replacement user data, other data, or a combination thereof. The replacement recovery data can be used to recover the modified version of the memory block as opposed to the current version of the memory block stored in the one or more memory devices. In one example, generating the recovery data can involve read-modify-write operations and Exclusive OR (XOR) operations. The read-modify-write operations can access the existing data before it is overwritten and the XOR operations can use the existing data to generate the modified recovery data before the modified recovery data and the new data are written to the memory block. Partial block generation module 422 can store the replacement recovery data in data store 419 as recovery data 245B. In one example, partial block generation module 422 can cause the memory controller to use multiple buffers for the read-modify-write operation. The multiple buffers can include a read buffer to store the existing recovery data and user data and include a write buffer to store the generated recovery data and replacement user data.

Entire block generation module 424 can enable memory controller 215 to generate recovery data based on the entire portion of user data of the modified version of the memory block 240. By using the entire portion, the memory controller 215 can avoid reading the existing user data at the portion being modified and avoid reading the existing recovery data. Instead, the entire block generation module 424 can generate the recovery data based on the replacement user data from the command and the existing user data from the remaining non-modified portion of the memory block. This can involve executing one or more read operations to access the existing user data in the portion of the memory block 240 that is not being modified. In one example, accessing the existing user data can involve one or more read operations that read from the memory units that are not being modified without reading from the memory units that are being modified. In another example, accessing the existing user data can involve one or more read operations that read all the user data from the entire memory block even though the user data at the portion being modified may not be used. In either example, entire block generation module 424 can generate and store the replacement recovery data in a buffer (e.g., write buffer).

Both the partial block generation module 422 and the entire block generation module 424 can generate recovery data that memory controller 215 can write to the memory device. The replacement recovery data can be written to the memory device before, during, or after the replacement user data is written to the memory device. In one example, the recovery data can be a part of the memory block and the memory controller can write the replacement user data and replacement recovery data to the corresponding portions within the memory block. In another example, the recovery data can be separate from the memory block and the memory controller can write the replacement user data to the memory block and the replacement recovery data to the portion that is associated with the memory block. In either option, the memory controller can write the replacement data over the existing data. The write can involve one or more operations that include erasing, updating, configuring, or formatting the data of the memory device (e.g., content or metadata).

As discussed above, memory controller 215 can perform one or more reads when processing a partial modification of the memory block. In one example, memory controller 215 can issue a read command to read the user data at the portion of the memory block without reading user data at a remaining portion of the memory block. Memory controller 215 can detect the user data that was read includes an error by analyzing error detection data. Memory controller 215 can then execute a recovery process to obtain the original user data by issuing a complementary read. The complementary read can read the remaining portions of the memory block that include the all the remaining user data in the memory block. Memory controller can then use the recovery data (e.g., existing or replacement) to generate a version of the user data that is absent errors.

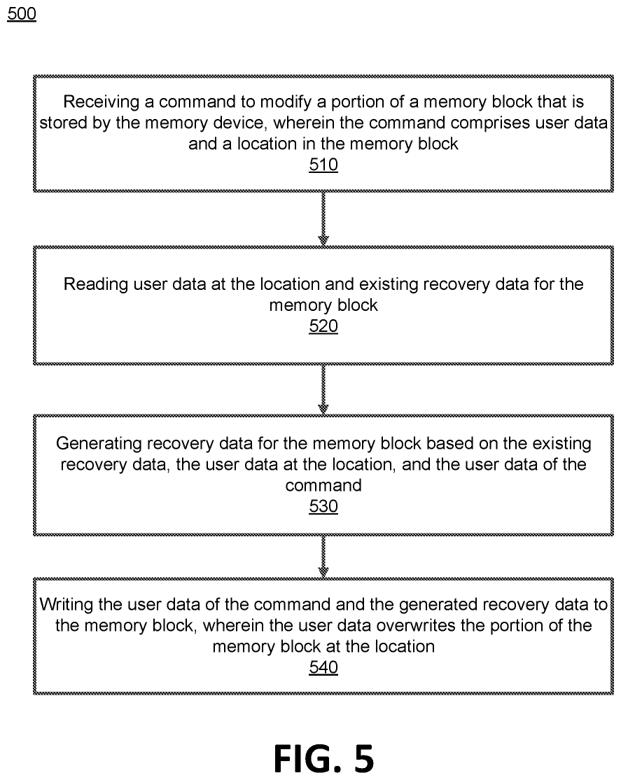

FIG. 5 is a flow chart of a method 500 for processing a command that modifies a portion of a memory block that is associated with recovery data, in accordance with an example embodiment. Method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by memory controller 215 of FIGS. 2-3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, processing logic can receive a command to modify a portion of a memory block that is stored by the memory device, wherein the command comprises user data and a location in the memory block. The processing logic (e.g., processing device/memory controller) can process multiple commands (e.g., partial write commands) that modify different size portions of the memory block. A write command that modifies a larger size portion can involve using an entire portion of the memory block to generate the recovery data and a write command that modifies a smaller size portion can involve a read-modify-write operation to update the recovery data without using the entire portion of the memory block.

In one example, the processing logic can evaluate a size of the portion being modified relative to a total size of the memory block. The evaluating can involve determining whether the size of the portion being modified is less than a threshold size (e.g., smaller portion) or greater than or equal to a threshold size (e.g., larger size). The threshold size can be a predetermined size relative to the total size of the memory block. Responsive to the size being less than the threshold size, the processing logic can perform a read-modify-write operation to perform the below reading and writing and avoid reading a remaining portion of the memory block. Responsive to the size being greater than the threshold value, the processing logic can read all the remaining portions of the memory block.

At operation 520, the processing logic can read user data at the location and existing recovery data for the memory block. The location can identify the beginning, middle, or end of the portion using one or more identifiers. The one or more identifiers can be or include a memory address or a hash of the stored content and can identify a portion of data that spans (e.g., is striped across) one or more memory devices. In one example, the memory device can be a set of multiple memory devices and the memory block can be a striped memory block that includes a set of portions and each portion of the set is stored on a different one of the memory devices.

At operation 530, the processing logic can generate recovery data for the memory block based on the existing recovery data, the user data at the location, and the user data of the command. The generated recovery data can correspond to an entire portion of the memory block and can be generated without using the entire portion of the memory block.

At operation 540, the processing logic can write the user data of the command and the generated recovery data to the memory block. The user data can overwrite the portion of the memory block at the location and the generated recovery data can overwrite the existing recovery data. In one example, the memory device can include non-volatile memory in a DIMM package and functions as Non-Volatile Random Access Memory (NVRAM).

In other versions of method 500, the processing logic can receive and process a read command that identifies the portion in the memory block. The processing logic can read the user data at the portion of the memory block without reading user data at a remaining portion of the memory block. If the processing logic detects the user data includes an error (e.g., based on Error correction data), the processing logic can recover the correct/original user data using a complementary read. The complementary read can access the remaining portion of the memory block comprising additional user data.

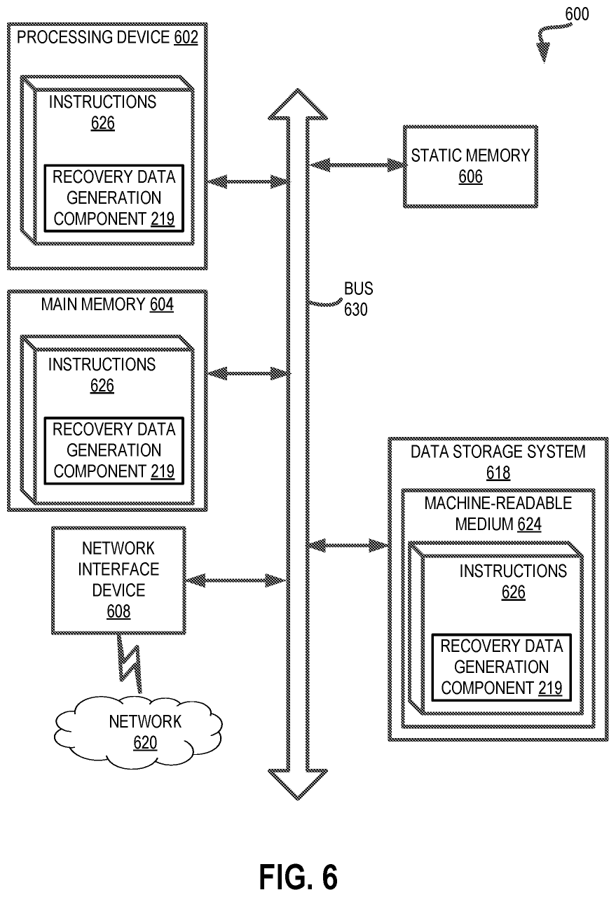

FIG. 6 illustrates an example machine of a computer system 600 within which a set of instructions, for causing the machine to perform any one or more of the methodologies discussed herein, can be executed. In some embodiments, the computer system 600 can correspond to a memory controller (e.g., the memory controller of FIGS. 2-3, and 5) that includes, is coupled to, or utilizes a memory sub-system (e.g., memory sub-system 110 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a non-transitory computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to the recovery data generation component 219 of FIGS. 1-4. While the machine-readable storage medium 624 is shown in an example embodiment to be a single medium, the term “non-transitory machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., non-transitory computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving a command to modify a first portion of a memory block that is stored by the memory device, wherein the command comprises user data and a location in the memory block;
reading user data at the location and existing recovery data for the memory block;
generating recovery data for the memory block based on the existing recovery data, the user data at the location, and the user data of the command without reading a second portion of the memory block; and
writing the user data of the command and the generated recovery data to the memory device, wherein the user data overwrites the portion of the memory block at the location.

2. The system of claim 1, wherein the generated recovery data corresponds to the first portion and second portion of the memory block.

3. The system of claim 1, wherein the operations further comprise, evaluating a size of the portion being modified relative to a total size of the memory block, wherein the evaluating comprises:
determining whether the size of the portion being modified is less than a threshold size, wherein the threshold size is a predetermined size relative to the total size of the memory block; and
responsive to the size being less than the threshold size, performing a read-modify-write operation to perform the reading and the writing and avoid reading a remaining portion of the memory block.

4. The system of claim 1, wherein the processing device processes commands that modify different size portions of the memory block, and a command that modifies a larger size portion involves using an entire portion of the memory block to generate the recovery data and a command that modifies a smaller size portion involves a read-modify-write operation to update the recovery data without using the entire portion of the memory block.

5. The system of claim 1, wherein the memory device comprises a set of memory devices and wherein the memory block comprises a striped memory block, the striped memory block comprising a set of portions and each portion of the set is stored on one of the memory devices.

6. The system of claim 1, wherein the memory device comprises non-volatile memory in a DIMM package and functions as Non-Volatile Random Access Memory (NVRAM).

7. The system of claim 1, wherein the operations further comprise:
receiving a read command that identifies the portion in the memory block;
reading the user data at the portion of the memory block without reading user data at a remaining portion of the memory block;
detecting the user data comprises an error; and
recovering the user data using a complementary read, wherein the complementary read accesses the remaining portion of the memory block comprising additional user data.

8. A method comprising:
receiving, by a processing device, a command to modify a first portion of a memory block that is stored by a memory device, wherein the command comprises user data and a location in the memory block;
reading user data at the location and existing recovery data for the memory block;
generating, by the processing device, recovery data for the memory block based on the existing recovery data, the user data at the location, and the user data of the command without reading a second portion of the memory block; and
writing the user data of the command and the generated recovery data to the memory device, wherein the user data overwrites the portion of the memory block at the location.

9. The method of claim 8, wherein the generated recovery data corresponds to the first portion and second portion of the memory block.

10. The method of claim 8, further comprising, evaluating a size of the portion being modified relative to a total size of the memory block, wherein the evaluating comprises:
determining whether the size of the portion being modified is less than a threshold size, wherein the threshold size is a predetermined size relative to the total size of the memory block; and
responsive to the size being less than the threshold size, performing a read-modify-write operation to perform the reading and the writing and avoid reading a remaining portion of the memory block.

11. The method of claim 8, wherein the processing device processes commands that modify different size portions of the memory block, and a command that modifies a larger size portion involves using an entire portion of the memory block to generate the recovery data and a command that modifies a smaller size portion involves a read-modify-write operation to update the recovery data without using the entire portion of the memory block.

12. The method of claim 8, wherein the memory device comprises a set of memory devices and wherein the memory block comprises a striped memory block, the striped memory block comprising a set of portions and each portion of the set is stored on one of the memory devices.

13. The method of claim 8, wherein the memory device comprises non-volatile memory in a DIMM package and functions as Non-Volatile Random Access Memory (NVRAM).

14. The method of claim 8, further comprising:
receiving a read command that identifies the portion in the memory block;
reading the user data at the portion of the memory block without reading user data at a remaining portion of the memory block;
detecting the user data comprises an error; and
recovering the user data using a complementary read, wherein the complementary read accesses the remaining portion of the memory block comprising additional user data.

15. A non-transitory computer-readable medium storing instructions, which when executed by a processing device, cause the processing device to perform operations comprising:
receiving a command to modify a first portion of a memory block that is stored by a memory device, wherein the command comprises user data and a location in the memory block;
determining a size of the portion is less than a threshold size;
responsive to the determining, reading user data at the location and reading existing recovery data for the memory block;
generating recovery data for the memory block based on the existing recovery data, the user data at the location, and the user data of the command without reading a second portion of the memory block; and
writing the user data of the command and the generated recovery data to the memory block, wherein the user data overwrites the portion of the memory block at the location.

16. The non-transitory computer-readable medium of claim 15, wherein the generated recovery data corresponds to the first portion and second portion of the memory block.

17. The non-transitory computer-readable medium of claim 15, wherein the processing device processes commands that modify different size portions of the memory block, and a command that modifies a larger size portion involves using an entire portion of the memory block to generate the recovery data and a command that modifies a smaller size portion involves a read-modify-write operation to update the recovery data without using the entire portion of the memory block.

18. The non-transitory computer-readable medium of claim 15, wherein the memory device comprises a set of memory devices and wherein the memory block comprises a striped memory block, the striped memory block comprising a set of portions and each portion of the set is stored on one of the memory devices.

19. The non-transitory computer-readable medium of claim 15, wherein the memory device comprises non-volatile memory in a DIMM package and functions as Non-Volatile Random Access Memory (NVRAM).

20. The non-transitory computer-readable medium of claim 15, further comprising:
receiving a read command that identifies the portion in the memory block;
reading the user data at the portion of the memory block without reading user data at a remaining portion of the memory block;
detecting the user data comprises an error; and
recovering the user data using a complementary read, wherein the complementary read accesses the remaining portion of the memory block comprising additional user data
